(19) United States
(12) Patent Application Publication
(10) Pub. No.: US 2019/0392387 A1
(43) Pub. Date: Dec. 26, 2019

(54) Peer-To-Peer Method For Facilitating Deliveries To Consumers

(71) Applicant: Kyung Ah Quan, Richmond (CA)

(72) Inventor: Kyung Ah Quan, Richmond (CA)

(21) Appl. No.: 16/406,697

(22) Filed: May 8, 2019

(30) Foreign Application Priority Data
May 11, 2018 (CA) 3,004,642

(51) Int. Cl. G06Q 10/08; G06Q 30/02; G06Q 20/14

(52) U.S. Cl. CPC G06Q 10/0838; G06Q 40/08; G06Q 20/14; G06Q 30/0282

(57) ABSTRACT

An improved method, computer program product and computing system for managing a peer-to-peer network to facilitate delivery services to consumers. The method is performed by a computing system. The method comprises processing a request from a candidate consignee to be included in a pool of consignees within a geographic region. This step comprises collecting consignee parameters including consignee location, times when available for receiving deliveries, times when available for deliveries to be picked up by consumers, fees, and contact information. The method admits a candidate consignee into the pool of consignees if the candidate consignee satisfies predetermined criteria for admission. The method processes a delivery request entered into the computing system by a consumer. The delivery request comprises consumer input on at least one delivery criterion selected from a list of predetermined delivery criteria. The method then validates a group of validated consignees from the pool that satisfy all the delivery criteria entered by the consumer and identifies the group of validated consignees to the consumer.

### FIELD OF THE INVENTION

The present application relates to a peer-to-peer method for facilitating deliveries to consumers. More particularly, the method helps consumers who cannot receive deliveries themselves to identify and choose a peer consignee to receive the delivery for them.

### BACKGROUND OF THE INVENTION

With the growth of e-commerce, it has become common to buy and sell products online or over the internet. Consequently, there has been a corresponding growth in the services for delivering e-commerce products to consumers. Some consumers are still hesitant to fully embrace e-commerce because of concerns with how the products are delivered. Some stores have local storefronts where the purchased products can be picked up, but many consumers do not have the time or convenient transportation to go and pick up the purchased item. If consumers would rather have a purchased item delivered, it can be a problem if the item is expensive and the consumer is unable to be at home to receive it. Usually the delivery truck is making deliveries all day and cannot guarantee a precise time that a delivery will be made. For example, if the estimated delivery timing is in the morning, the purchaser might have to wait at home all morning before the item is delivered. If the consumer instructs the delivery service to leave the purchased item at the front door, there is a risk that it could be stolen. If the consumer lives in an apartment, it may not be possible to receive a purchased item if the consumer is not at home. Some companies are testing technologies that will allow a delivery person temporary access into a person's home to deliver purchased items when the consumer is not at home, but it has been demonstrated that hackers can exploit this technology to break into people's homes.

While e-commerce already has taken a significant share of the retail market, this share could grow even larger if shortcomings with current delivery methods can be overcome. With a more efficient delivery method, purchasing products by e-commerce can be much more efficient and convenient for consumers compared to travelling to stores in person, purchasing items from each store, and bringing them home.

Delivery to the homes of consumers is also a problem for delivery companies. Unless a consumer works from home, the consumer is often not at home during delivery hours, and this can result in repeated attempts by the delivery company to make the delivery, especially when the recipient's signature is required to confirm delivery. This results in wasted trips and makes deliveries inefficient, adding to the costs incurred, which are passed along to the consumer, resulting in higher delivery charges. In many cases if a delivery company can not complete the delivery within a fixed number of attempts, the consumer must retrieve the purchased item from the delivery company's warehouse or a designated pick-up location, which could be far from the consumer's home and/or inconvenient to get to.

Addressing the shortcomings with current delivery methods will also be a benefit to e-commerce vendors. A more efficient delivery method can allow faster delivery at lower cost, which makes e-commerce more attractive. That is, improvements to delivery methods that benefit consumers will help e-commerce vendors to gain more market share. Furthermore, this problem is not exclusive to e-commerce. Any consumer who is purchasing an item from a local store, but who can not attend the store in person or who does not have a vehicle for bringing the item home can also benefit from alternative delivery methods.

Accordingly, an improved method of delivering consumer purchases can be beneficial for consumers, delivery companies, and vendors. The patent prior art discloses many solutions for making deliveries more efficient for delivery companies, and while making deliveries more efficient for delivery companies indirectly benefits consumer by reducing delivery costs which are passed along to consumers in a competitive marketplace, these solutions do not address all the shortcomings of current methods that make deliveries of purchased items to consumers inconvenient or unsecure from the consumer's perspective.

Japanese Patent 6286072B2, which has a title that has been translated into English as, “Device and method for providing a home delivery box used in the unmanned favorite goods prior delivery service, the computer program recorded in the recording medium”, is one of many examples of delivery methods that deliver purchased items to an unmanned “parcel box” instead of to the consumer's home or office. U.S. Pat. No. 9,898,711B2, entitled “System and method for shipping and delivering parcels to a virtual address”, is another example of a computer-based system and method for shipping and delivering a parcel. This method includes reserving a terminal for a parcel; placing the parcel in the terminal, the parcel having a virtual delivery address of a recipient; picking up the parcel by a carrier; converting, through a central computer system, the virtual address into a postal address; delivering the parcel to a destination terminal drop-box corresponding to the postal address; notifying the recipient of the delivery of the parcel; and unlocking the drop-box only upon verifying the recipient's identity. A benefit of these methods is that the consumer can go to the parcel box at his or her convenience to pick up the purchased item. However, a drawback is that the consumer still needs to travel to the parcel box, which may not be at a location that is convenient for the consumer. If the consumer cannot pick up the parcel right away, the parcel box can remain occupied for an extended period, which is inefficient. Also, the finite number of parcel boxes can result in times when all the parcel boxes are occupied such that no more parcels can be received, and other times when there is a very low use-rate when there are a lot of empty parcel boxes. This can be especially problematic, for example, during holiday times like Christmas, when it could be difficult for consumers if there are not enough parcel boxes to handle the volume of parcels being shipped, putting limits on this method that make it ineffective during peak use times. The owner of the parcel box, which could be the delivery company or an independent business, has a self-interest to be located close to other businesses, which might increase use of the parcel boxes, but this could be a location where there is also more traffic congestion. In other locations where land is more expensive near where the consumer lives, the parcel boxes may be located further away where the land is less expensive. Because there is an investment required to build and maintain the parcel boxes, this may limit the number of parcel box locations and they may be positioned to serve a large territory that includes more than one neighbourhood, which can result in a long travel distance for the consumer to get there if the consumer lives towards the edge of the territory served.

Some companies have storefront locations to which a consumer can have a purchased item delivered. Japanese Patent 6,262,841B2, which has a title that is translated into English as, “The manned collection and delivery system and method for transferring loads from the base scheduled” discloses a computer system for ranking potential attended delivery/pickup locations to assist consumers in selecting the best location. A problem with this solution is that, like the unattended parcel boxes, the attended delivery/pickup locations must be built, maintained, and staffed by the delivery company. While this allows the consumer to choose the best location within the delivery company's network of available locations even the best location may still not be convenient for the consumer, especially if access is limited to when the store is open. This patent also describes an embodiment that allows the consumer to choose a retail store for the delivery/pickup location. In a disclosed example, a consumer can purchase shoes online from the shoe manufacturer and request them to be delivered to a local shoe store. The consumer must still travel to the shoe store in the consumer's city, and this shoe store could still be inconvenient to get to. Choices for delivery/pick up are still limited to locations established by the delivery company or retailers, which are located to best serve the interests of the business, not the convenience of the consumer.

U.S. Pat. No. 9,898,711B2, entitled “System and method for shipping and delivering parcels to a virtual address”, is another example of a computer-based system and method for shipping and delivering a parcel, including reserving a terminal for a parcel; placing the parcel in the terminal, the parcel having a virtual delivery address of a recipient; picking up the parcel by a carrier; converting, through a central computer system, the virtual address into a postal address; delivering the parcel to a destination terminal drop-box corresponding to the postal address; notifying the recipient of the delivery of the parcel; and unlocking the drop-box only upon verifying the recipient's identity.

Canada Patent Application 2,942,296A1, entitled “Determining Alternative Delivery Destinations”, discloses a method that helps a delivery company to deliver purchased items. This patent discloses systems, methods, apparatus, and computer program products that are provided for determining alternative delivery destinations. For example, a consumer can designate a default delivery location and a first priority alternative consignee who can receive the purchased item if the consumer is not available to receive the purchased item at the default delivery location. This method still requires the consumer to manage the delivery process, and to indicate to the delivery company a change in the delivery instructions to deliver the item to the first priority alternative consignee if the consumer would prefer to receive the purchased item at that location instead of the default delivery location. However, while this method offers a solution for the delivery company to complete the delivery by allowing the consumer to designate an alternative consignee, it requires the consumer to actively manage the delivery process and it does not help the consumer to find an alternative delivery location. The consumer must already know an alternative delivery location.

U.S. Pat. No. 9,070,101 bearing the title, “Peer-to-Peer Neighborhood Delivery Multi-Copter and Method”, discloses a method for an autonomous neighborhood multi-copter commerce network in a community. A neighbourhood multi-copter has a computer system that is communicatively coupled to a commerce server of a neighbourhood communication system through a wireless network to autonomously navigate the multi-copter to a destination for delivering items using a peer-to-peer network of client-side devices. There are several problems with this approach. For example, it is vulnerable to hackers who could take over control of the multi-copter. If the multi-copter delivers the purchased items to the doorstep of the recipient, the purchased items could be stolen. The multi-copter itself and the required neighbourhood communication system add infrastructure cost to the users. The multi-copter will require maintenance and fueling or charging, adding to the operational costs.

US Patent Application 2014/0278851A1, entitled “Method and a trusted social network platform for facilitating peer-to-peer shipment delivery” discloses a method of using a trusted social network platform that comprises a trip management module configured to receive details of a trip of a trusted traveler, and a shipping information module configured to receive a package shipment request from a trusted shipper. The trusted traveler and the trusted shipper have a pre-existing trust relationship through a trusted social network such that the trusted shipper is authorized to send one or more package shipment requests for the trusted traveler. The trusted social network platform also comprises a traveler-shipment matcher module configured to match the package shipment request with the trusted traveler to facilitate peer-to-peer shipment delivery and a reward management module configured to provide rewards to the trusted traveler and the trusted shipper. This is another solution that is directed to assisting the delivery process by matching a shipping company with trusted travelers who can make the deliveries. It does not provide a means for helping to make the delivery more convenient for the consumer.

Accordingly, most of the solutions offered so far are directed to making deliveries more efficient for the delivery companies, but there remains a need for a method of making deliveries more convenient and more secure for consumers.

### SUMMARY OF THE INVENTION

A method is disclosed for facilitating delivery services by making them more convenient and secure for consumers and more efficient for delivery companies and vendors. The method is performed by a computing system and comprises processing a request from a candidate consignee to be included in a pool of consignees within a geographic region, this step comprising collecting consignee parameters including consignee location, times when available for receiving deliveries, times when available for deliveries to be picked up by consumers, fees, and contact information. If the candidate consignee satisfies predetermined criteria for admission into the consignee pool, the computing system admits the candidate consignee into the pool of consignees. The computing system processes a delivery request by a consumer entering into the computing system consumer input on at least one delivery criterion selected from a list of predetermined delivery criteria. The method further comprises validating a group of validated consignees from the pool of consignees that satisfy all delivery criteria entered by the consumer. Then the computing system identifies to the consumer the group of validated consignees.

The list of predetermined delivery criteria entered into the computing system by the consumer comprises at least one of: distance from a specified location, fees, times available when the consignee is available for receiving deliveries, times available when consignee is available for deliveries to be picked up, and a rating assigned to consignees by other consumers. For example, if the consumer selects distance from specified location as one of the delivery criterion, the consumer specifies a maximum distance from a consumer specified location and then the computing system calculates the distance between each consignee location and the consumer specified location and validates each consignee that meets this criterion. If other delivery criteria are entered by the consumer then the computing system eliminates consignees in the pool that do not satisfy any one of the criteria and validates only those consignees that satisfy all the consumer specified delivery criteria.

In some embodiments the method further comprises applying a predetermined ranking method based upon the consumer input in the delivery request and assigning ranks to the validated consignees. If distance from a specified location within the geographic region is one of the selected delivery criteria, the ranking method calculates and communicates to the consumer distances between each validated consignee and the specified location. The predetermined ranking method is based on assumptions about which criteria are most important to the consumer, and can be weighted so that some criterion, such as distance from the consumer specified location are given more importance than other criteria. Having a default predetermined ranking method simplifies the delivery request process for most consumers. However, some consumers may want to individualize their experience and customize the weightings for the different criteria used for ranking consignees. Accordingly, in some embodiments, the consumer can override the predetermined ranking method by entering consumer-defined weightings to the selected delivery criteria whereby the computing system assigns customized rankings to validated consignees according to a consumer's individual preferences.

In preferred embodiments, the method further comprises the computing system soliciting and collecting from consumers, quantifiable satisfaction ratings for consignees in the pool of consignees and including the quantifiable satisfaction ratings on the predetermined list of delivery criteria. In addition, the method can further comprise the computing system soliciting and collecting from consignees, quantifiable satisfaction ratings for consumers, and wherein consignees can include in their individual consignee parameters a minimum satisfaction rating for consumers, for accepting delivery requests, whereby a consignee is not included in the group of validated consignees for a delivery request when the delivery request is received from a consumer with a satisfaction rating below the minimum satisfaction rating for consumers, according to ratings from other consignees. That is, in establishing a peer-to-peer community based upon trusted relationships, the ratings from others within the peer community of both consumers and consignees is useful information that consumers can use in deciding whether to select a particular consignee, and that consignees can use for screening out consumers who are poorly rated by other consignees.

In addition, or as an alternative to quantifiable ratings, the method can further comprise the computing system soliciting and compiling reviews of consignees from consumers concerning consignees in the pool and making the reviews of consignees available to consumers. As with the quantifiable ratings, the method can allow reviews both ways, with the computing system soliciting and compiling reviews of consumer from consignees concerning consumers who have used the method for facilitate delivery services and making the reviews of consumers available to consignees in the pool of consignees. Consumers and consignees can use the reviews to get a better insight into what people like (or dislike) about the person being reviewed, which can be more helpful than a numerical rating.

The method can manage the reviews of consignees and the reviews of consumers by doing at least one of: (i) verifying that reviews are authentic; (ii) providing a process for responding to reviews; or (iii) taking down reviews that do not comply with predetermined guidelines for appropriate content. For reviews to be useful, the users need some level of confidence that the reviews are authentic and not just from the consignee, consumer, or their agents, who are attempting to boost their profile. The administrator of the computing system may also want to manage the content to be sure that comments are fair, truthful and respectful, and to keep content free of bullying and comments that might otherwise be considered abusive or threatening.

The computing system can also collect input from people on whether they thought a particular review was helpful. Then the computing system can show the most helpful reviews first to make it easier for users to access the most helpful reviews. The computing system can also allow users to choose how they want to rank the reviews, for example, with the most recent shown first, or ordered with the lowest ratings first, or with the highest ratings first or with some other metric used as the basis for organizing the order in which reviews are displayed to the user.

When a candidate consignee applies to be admitted into the consignee pool, the computing system can include in the predetermined criteria for admission comprises at least one of: (i) information that verifies the identity of the candidate consignee; and (ii) information that supports the trustworthiness of the candidate consignee. This could include requiring the candidate consignee to agreeing to undergo a criminal record check. Peer-to-peer networks depend upon establishing trust and one of the features of using the subject method is that the consumers can feel comfortable that the consignees in the pool have been vetted prior to being admitted into the consignee pool.

The method in its most simple form manages admission of candidate assignees into the consignee pool, accepts delivery requests from consumers, and then validates consignees who satisfy the delivery criteria specified by the consumer in the delivery request, and then identifies these validated consignees to the consumer. At another level, the scope of the method can include ranking the validated consignees according to a predetermined ranking method or according to a consumer customization of the ranking method. At yet another level the scope of the method can comprise adding even more features to assist the consumer beyond just selecting a consignee. For example, the method can further comprise facilitating and coordinating the transaction between the consumer and the consignee. For example, additional steps to the method can include: the consumer choosing a selected consignee from the group of validated consignees and entering the selected consignee into the computing system; the computing system sending the delivery request to the selected consignee; the computing system collecting the selected consignee's fee from the consumer and issuing a release code to the consumer; the consumer giving the release code to the selected consignee to collect a delivered item; and the selected consignee entering the release code into the computing system to trigger disbursement of the selected consignee's fees to the selected consignee.

Additional features can comprise the selected consignee notifying the consumer through the computing system when the delivered item has been received. The method can also include the consumer and the selected consignee communicating through the computing system to coordinate a confirmed time for the consumer to pick up the delivered item from the selected consignee.

There are costs for the administrator of the computing system, and the services provided to consumers to facilitate deliveries provides a value to consumers are services that can be part of a business that is operated by the administrator to generate revenue. Part of the revenue can be advertising revenue that is displayed to consumers and consignees when they access the computing system through their respective interface devices. The administrator can also collect administration fees when consumers use the computing system to facilitate deliveries. In some embodiments, the selected consignee's fee includes an administration fee that is retained by the administrator of the computing system.

The method can include features that add value to the consumer, such as insurance against damage to the delivered item when in the care of the consignee. Accordingly, the method can further include using part of the administration fee is used to pay for an insurance policy so that consumers can make claims against the insurance policy if the delivered item is damaged while in the care of the selected consignee.

The method can also allow consignees to offer additional services that make choosing them more appealing compared to other consignees in the pool. In some embodiments, consignees can use the computing system to communicate to consumers other services that they offer. For example, a consignee can include an offer through the computing system to deliver received items to the specified location at a time determined by the consumer for an additional fee. While this adds an additional delivery cost, it can address a consumer need, because of the advantages of this service compared to delivery by a courier or post office. That is, the consumer can choose a more precise time when the item will be delivered, since the consumer can choose a consignee in close proximity, there is less uncertainty in the time when delivery can be made, because traffic is less of a factor, and because the delivery distance can be short, costs for delivery in terms of fuel and time, is much less than the initial delivery to the consignee so the fee for delivery to the consumer can be modestly priced. For large or heavy items, the consumer might prefer to pay for this additional service to have an item delivered to his or her door, instead of going to the consignee to pick it up.

Also disclosed is a computer program product for facilitating delivery services. The computer program product comprises code which, when loaded into memory and executed on a processor of a computing device, is adapted to execute the subject method as disclosed in each of the embodiments, including the most basic method that simply identifies validated consignees to the consumer, and all of the other disclosed embodiments with some or all of the different features disclosed herein.

Also disclosed is a system for facilitating delivery services. The system comprises: (i) a consignee interface device configured to receive a request from a candidate consignee to be included in a pool of consignees within a geographic region, the request including consignee parameters including consignee location, fees, times when available for receiving deliveries, and times when available for retrieval of delivered items by consumers, and contact information; (ii) a consumer interface device configured to receive a delivery request from a consumer the delivery request comprising consumer input on at least one delivery criterion selected from a list of predetermined delivery criteria; (iii) a computing system communicatively coupled to the consumer interface device and the consignee interface device; the computing system configured to: admit the candidate consignee into the pool of consignees if the candidate consignee satisfies predetermined criteria for admission; validate a group of validated consignees from the pool of consignees that satisfy all delivery criteria entered by the consumer; and identify validated consignees and associated consignee parameters to the consumer.

The computing system can be configured to apply a predetermined ranking method based upon the consumer input in the delivery request and to communicate an assigned rank to each one of the validated consignees to the consumer through the consumer interface device.

The computing system can be configured to allow the consumer to override the predetermined ranking method through the consumer interface device by entering consumer-defined weightings to the selected delivery criteria whereby the computing system uses the consumer-defined weightings to compute and assign customized rankings to validated consignees according to a consumer's individual preferences.

In preferred embodiments, the computing system can be configured to solicit from consumers, through the consumer interface device, to save quantifiable satisfaction ratings for consignees in the pool of consignees, to include the quantifiable satisfaction ratings on the predetermined list of delivery criteria, and to make the quantifiable satisfaction ratings available to consumers through the consumer interface device. Likewise, the computing system can also be configured to solicit, through the consignee interface device, and to save, quantifiable satisfaction ratings for consumers from consignees, and wherein consignees can include in their individual consignee parameters a minimum satisfaction rating for accepting delivery requests, whereby a consignee will not be included in the group of validated consignees for a delivery request received from a consumer with a satisfaction rating below the minimum satisfaction rating.

Instead of, or in addition to quantifiable satisfaction ratings, the computing system can be configured to solicit, through the consumer interface device, reviews of consignees from consumers concerning consignees in the pool; to compile the reviews of consignees; and to make the reviews of consignees available to consumers through the consumer interface device. Likewise, the computing system can also be configured to solicit, through the consignee interface device, reviews of consumers from consignees concerning consumers who have used the method for facilitate delivery services; to compile the reviews of consumers; and, to make the reviews of consumers available to consignees in the pool of consignees through the consignee interface device. With the reviews that are collected and compiled, the computing system in some embodiments the computing system is configured to manage the reviews of consignees and the reviews of consumers by doing at least one of: (i) verifying that reviews are authentic; (ii) providing a process for responding to reviews; or (iii) taking down reviews that do not comply with predetermined guidelines for appropriate content.

The system can include features that help to improve the safety and security of deliveries that are facilitated using the computing system and method. This adds value to consumers and generates an environment where it is easier to establish trust between consumers and consignees. The reviews and ratings are part of these features. As another feature, the system can be configured with predetermined criteria for the admission of candidate consignees into the consignee pool, and such predetermined criteria can comprise at least one of: (i) information that verifies the identity of the candidate consignee; and (ii) information that supports the trustworthiness of the candidate consignee. This information could include references, a criminal records check that verifies no criminal history, and a credit report.

In a preferred embodiment of the system, the computing system is configured to: (i) receive a consumer selection, through the consumer interface device, of a selected consignee from the group of validated consignees; (ii) send the delivery request to the selected consignee through the consignee interface device; (iii) collect the selected consignee's fee from the consumer and issuing a release code to the consumer, the release code allowing the consumer to collect a delivered item from the selected consignee; and (iv) disburse the selected consignee's fee to the selected consignee when the selected enters the release code into the computing system through the consignee interface device. When the delivery has been made to the consignee, the computing system can be configured to process messages between the consumer and the selected consignee to coordinate a confirmed time for the consumer to pick up the delivered item from the selected consignee. That is the system is configured for the consumer and the selected consignee to communicate through the computing system by means of respective consumer and consignee interface devices.

### BRIEF DESCRIPTION OF THE DRAWINGS

FIG. 1 is a drawing that shows a system for facilitating delivery services.

FIG. 2 is a flow diagram that illustrates an embodiment of the method of facilitating delivery services.

### DETAILED DESCRIPTION OF ILLUSTRATIVE EMBODIMENT(S)

Reference is now made in detail to the present preferred embodiments, examples of which are illustrated in the accompanying drawings. Whenever possible, the same reference numerals are used throughout the drawings to refer to the same parts, and if the parts are the same and indicated by the same reference numeral, for brevity such parts may not be re-introduced and described with respect to each drawing. If the parts are not the same, but similar in function, like reference numerals are used.

The following detailed description represents embodiments that are intended to provide an overview or framework for understanding the nature and character of the claims. The accompanying drawings are included to provide further understanding of the claims and constitute part of the specification. Accordingly, the detailed descriptions and drawings are non-limiting to the scope of what is claimed and are intended to illustrate and explain the principles and operations of these embodiments, as claimed.

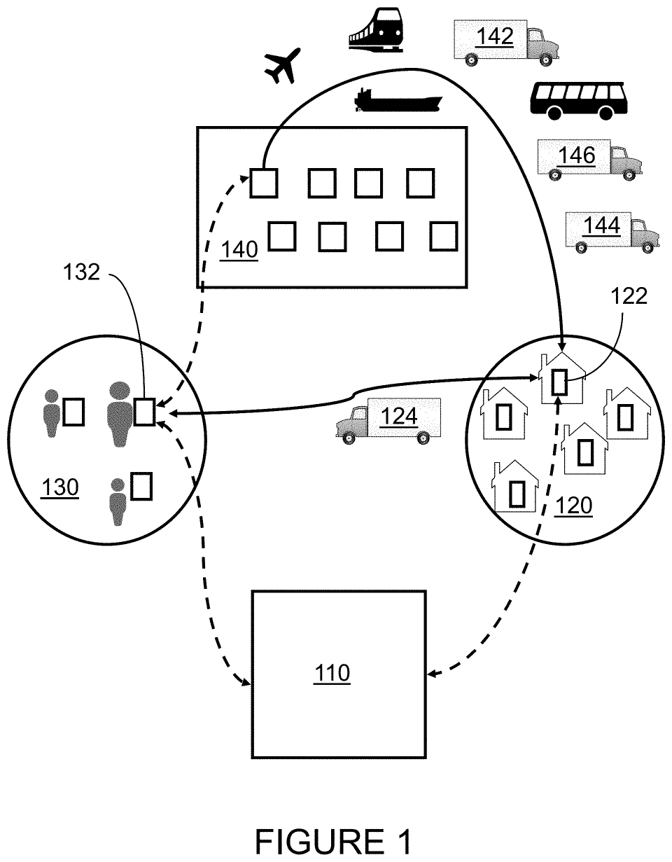

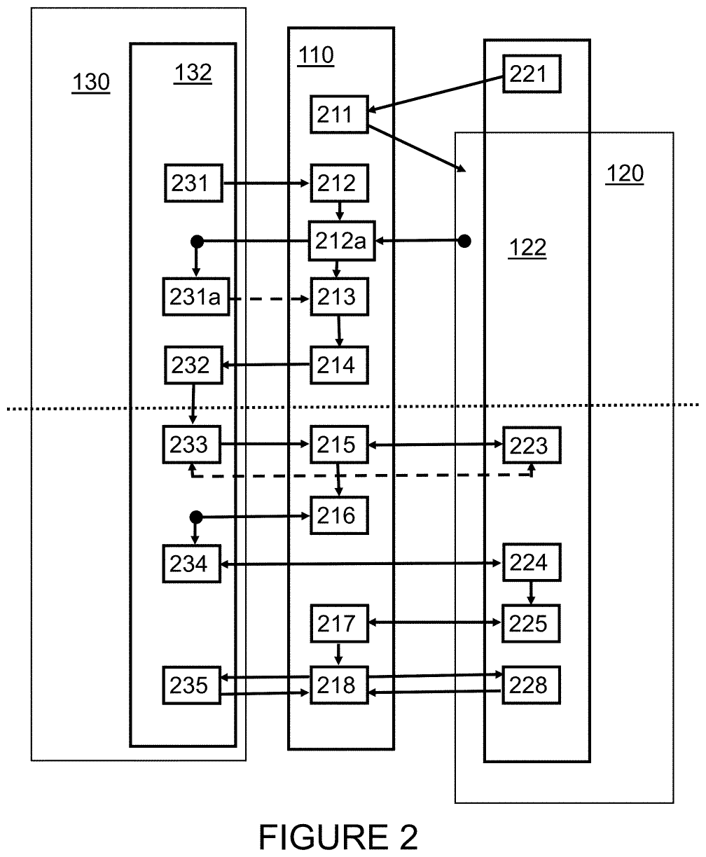

With reference to FIG. 1, a system for facilitating deliveries to consumers is illustrated for implementing the method illustrated in the flow diagram of FIG. 2. The method shown in FIG. 2 is described with reference to the system illustrated in FIG. 1. In FIG. 1 the dashed lines represent data communication links and the solid lines represent the delivery path of the purchased item from the vendor in pool 140 to the consumer in pool 130. Communication along the dashed lines can be conveyed by one type or a combination of types of data communication links including wired connections, fiber optic networks, and wireless networks. Delivery of purchased items from vendor pool 140 to consignee pool 120 can be by conventional delivery methods, for example and without limitation, by using the vendor's own delivery trucks 142, couriers 144 or mail carriers 146, bus, train, airplane, ship, or some combination of delivery and transportation methods. As will be described in more detail below, there are various options that a consumer can choose from for transferring the purchased item from the consignee in pool 120 to the consumer in pool 130. To better illustrate how the system works, FIG. 1 shows the data links and delivery path associated with the delivery of one purchased item to a consumer. When the subject multi-user peer-to-peer delivery method is operating, a plurality of communication links and delivery paths can be active at the same time.

The method requires computing system 110 to process requests from candidate consignees who are not yet admitted into consignee pool 120. These requests are made in step 221 (FIG. 2) through consignee interface devices 122, which can be any device capable of loading and running a computer program and that can be connected to the internet. For example, consignee interface device 122 can be a computer, a tablet, or a smart phone. Each candidate consignee requests to be registered by computing system 110 to participate in a delivery service program enabled by computing system 110. Each candidate consignee provides consignee parameters through consignee interface device 122. Computing system 110 uses the consignee parameters to match candidate consignees with consumers in user pool 130 who need a consignee from consignee pool 120 to receive a delivered purchased item on their behalf. The consignee parameters can include consignee location (for example, address and/or GPS location coordinates), dates available for receiving deliveries, times available for deliveries to be picked up by consumers, fees, contact information, and any other information that will help consumers to choose a candidate consignee that is the best match for their needs. Some consignees can specify a maximum package size, or a fee schedule that charges different amounts depending upon the size of the package, and fees for the number of days that the purchased item is held, or a surcharge if the purchased item is not picked up within a predetermined number of days. In method step 211 computing system 110 processes the candidate consignee's request to enter the consignee pool and if the candidate consignee satisfies the administrator-determined criteria for acceptance, the candidate consignee is allowed into consignee pool 120. In preferred embodiments in addition to satisfying the administrator-determined criteria before the candidate consignee is admitted into consignee pool 120, the candidate consignee must enter into a consignee agreement with the administrator. Terms of the agreement can include a covenant by the candidate consignee against marking arrangements directly with consumers to receive packages without using computing system 110. In addition, the terms of agreement can include terms relating to responsibility for packages damaged by the consignee, terms relating to standards of conduct with consumers, and appropriate behavior, for example with respect to content in consignee reviews of consumers, and consignee responses to reviews of consignees by consumers. Once a candidate consignee is admitted into consignee pool 120 it is eligible to be selected by a consumer.

Vendor pool 140 represents vendors who can be any store that takes orders for products that are deliverable to consumers. That is, a vendor can be an e-commerce store that only sells products online or it can be a store the sells locally but that also sells online to gain access to markets beyond its own geographical region, while also selling products to consumers in the same geographical region. Some stores have realized that some of their customers in the same geographical region do not have time to visit their location or who would just prefer the convenience of having an item delivered. Some stores offer free shipping, and this adds to the convenience of purchasing products in this way. When consumers purchase products from a vendor, whether the vendor makes the delivery itself or through a delivery company, the consumer can tell the vendor where to deliver the purchased item and ask for the delivery details, such as the estimated delivery date and the expected delivery time. If the delivery time is not convenient for the consumer, a consumer in consumer pool 130 can decide to use a peer-to-peer delivery service by making a request to computing system 110.

To use a peer-to-peer delivery service, in method step 231 the consumer enters a delivery request through consumer interface device 132. Consumer interface device 132, like consignee interface device 122, is any device capable of loading and running a computer program and connecting to the internet. The delivery request includes consumer input on at least one delivery criterion selected from a list of predetermined delivery criteria. For example, one of the predetermined delivery criteria can be a specified location near to which the consumer would like the package to be delivered. This will often be the consumer's home, but it need not be. It could be the place where the consumer works, or the address of a relative or friend. However, unlike prior art methods where the consumer must choose a delivery pick-up location from a list of locations, for example, unattended parcel boxes or store-front pick-up locations, which are delivery locations provided by the delivery company, with the subject method the consumer is able to choose a location that is more convenient for the consumer, and then computing system 110 will help the consumer to select a consignee that is close to the consumer specified location. Other predetermined delivery criteria can include consignee fees, times when the consignee is available for receiving packages, times when the consignee is available for delivered packages to be picked up by the consumer, and quantitative ratings assigned to consignees by other consumers. Computing system 110 can optionally require the consumer to input additional package characteristics such as the dimensions and weight of the purchased item. Based upon the delivery criteria and the consignee parameters of the consignees in consignee pool 120, in method step 212 computing system 110 processes the delivery request and in step 212a computing system 110 validates a group of validated consignees from consignee pool 120 and identifies the validated consignees to the consumer so that the consumer can select one of the validated consignees for receiving a package. The delivery request made in step 231, can include information that helps to further filter out consignees from those that are validated. For example, the consumer can enter the estimated delivery time and estimated delivery date, which allows computing system 110 to filter out any consignees in pool 120 that are not available to receive the purchased item on the estimated delivery date or at the estimated delivery time. If package dimensions and weight are part of the delivery criteria entered by the consumer, these can also be used to filter out any candidate consignees who are unable to receive items because of limitations on the dimensions or weight of packages that the consignee is able to receive. In one embodiment of the method, the identification of the validated consignees to the consumer is the final step in the method.

In other embodiments of the method, the method further comprises additional steps. As shown in FIG. 2, after validation step 212a the method can proceed to ranking step 213 in which computing system 110 processes the delivery criteria and the consignee parameters to rank validated assignees to further assist the consumer in choosing a consignee. In Step 231a the consumer can optionally enter consumer-defined weightings to the selected delivery criteria whereby in step 213 computing system 110 assigns customized rankings to validated consignees according to the consumer's individual preferences. For example, if proximity of the consignee to the specified location is the paramount concern than a higher weighting can be assigned to the distance of the consignees from the specified location. However, if price is also important, then the consumer can give an equal or higher weighting to fees. Likewise, if peer ratings are deemed important a weighting corresponding to the importance of this factor can be inputted in step 231a. If no consumer-defined weightings are inputted in step 231a, then in step 213 computing system 110 can apply a default predetermined ranking method to assign ranks to the validated consignees based upon the inputted delivery criteria and the consignee parameters for the validated consignees.

Whether the consumer uses the default predetermined ranking method or a custom ranking method that uses consumer-defined weightings for delivery criteria, in method step 214 computing system 110 compiles a list of validated consignees in ranked order that the consumer receives in method step 232. In some embodiments, the consumer can request details behind the ranking to be revealed, for example to show delivery criteria and consignee parameters for each validated consignee, and this can include the calculated distance that each candidate consignee is from the consumer specified location. In a preferred embodiment the consumer can choose whether to receive the information about the consignees in a list format or in a map view, that shows the location of the highest ranked candidate consignees relative to the consumer's location. The list format can include more of the stored information associated with each of the candidate consignee's parameters so the list format and the map view both show useful information. In a preferred embodiment it is possible for the consumer to switch back and forth or if a computer with a large screen is being used as the consumer interface 132 the consumer can also select a side-by-side split-screen view. When the map view is selected, it can be configured to allow the consumer to select a location to open a window that displays more information about the consignee.

Computing system 110 can be configured to provide additional features to further assist the consumer in the selection of a candidate consignee. For example, in step 218, computing system 110 can solicit and collect quantifiable satisfaction ratings from consumers in consumer pool 130 for candidate consignees in consignee pool 120. In one embodiment the quantifiable satisfaction ratings can be numeric using a predetermined number range or percentage of satisfaction. In other embodiments, instead of using numbers, satisfaction ratings can be in the stars, for example a zero or 1-star rating is a poor satisfaction rating whereas a 5-star rating is an excellent satisfaction rating. When many satisfaction ratings are compiled, this could result in fractional ratings, for example 4.3 stars or a 77% satisfaction rating. Computing system 110 can include the quantifiable satisfaction ratings in the consignee parameters that are displayed to the consumer in the selection step or it could be one of the predetermined delivery criteria that can be selected by the consumer in step 231. To facilitate verification of consumer ratings, computing system 110 can assign a unique reference number for each delivery request and require this reference number to be entered when a consumer gives a satisfaction rating to prevent the entry of false ratings from people or malignant robots. The reference number can also make it easier to verify that the consumer review is associated with a particular consignee that was selected by the consumer who gives a satisfaction rating. That is, before accepting a rating that is submitted by a consumer in step 235, computing system 110 can require that the entered reference number match a delivery service associated with the candidate consignee that is being rated. The computing system can optionally require that the rating be given within a predetermined time frame from when the delivery service was provided.

Similarly, computing system 110 can be further configured to solicit and collect written reviews from consumers to comment on their experiences in using the services of a particular candidate consignee. Like with the quantifiable satisfaction ratings, to reduce the likelihood of false reviews, or reviews being associated with the wrong candidate consignee, consumers can be required to enter the reference number associated with the consumer's use of a particular candidate consignee before a review for that consignee is accepted. These written reviews can be made a part of the candidate consignee's consignee parameters or accessed by consumers with a link on the consignee parameters. While most consumers will understand that even good service providers will occasionally receive a bad review, if a candidate consignee suspects that it has received a false or malicious review, computing system 110 can receive requests from a candidate consignee to investigate the legitimacy of a review and if the review is found to be false, computing system 110 can remove it. Alternatively, computing system 110 can allow reviewers to select an option that allows them to be contacted by the consignee, so that the consignee can attempt to rectify any problems that caused a consumer to complaint. By giving the consignee an opportunity to fix the problem, this improves the quality of service that is given to consumers.

In some embodiments, in step 218 computing system 110 can be further configured to solicit and collect ratings or written reviews from consignees to rate or comment on their experiences with consumers who have used their consignee services. Like with the consumer generated ratings and reviews of consignees, consignees can be assigned a unique reference number to facilitate the verification of the legitimacy of submitted reviews. In step 228, if a consignee had a good experience with a consumer the consignee can give the consumer a high rating or good review. If the consignee had a bad experience with the consumer, for example, if the consumer was unreasonably slow in picking up the package, or rude or abusive in some other way, the consignee can give a low rating or a bad review. In some embodiments an extra feature that can be offered is for consignees in the pool to require a minimum consumer rating before being validated. That is, if the consignee requires a minimum 2-star rating for consumers, then even if the consignee satisfies all the delivery criteria, the consignee will not be included in the list of validated consignees if the consumer has a rating lower than 2-stars.

Also, with embodiments that include reviews, whether for consignees or consumers, the respective consignee or consumer interface can provide a means for users to respond to reviews. That is, if one party gives a positive review, the other party can thank the reviewer. If one party gives a bad review, the other party can provide an explanation or describe what they are doing now to prevent whatever happened to cause the bad review. For such forums, the users can be bound by a code of conduct, and a user agreement under which content which does not comply with predetermined standards can be removed.

In the embodiments described above, the method of facilitating deliveries to consumers can be a community-based two-sided online marketplace that simply matches consumers with consignees to make receiving deliveries more convenient for the consumer, while also reducing the number of delivery attempts by the delivery company. This can be very helpful for consumers who work during normal delivery hours. Consignees can be stay-at-home parents, retired people, students, people that work from home, and local businesses that have hours that are compatible with delivery times and times for pick up by the consumers. Compared to current solutions that limit pick up locations to delivery company depots and fixed pick up locations that range of people that can request to be candidate consignees enables the consumer to pick a consignee with parameters that are the most convenient for the consumer to retrieve the purchased item.

In this embodiment the administrator of computing system 110 can generate revenue from advertisers, which could include e-commerce vendors, and courier companies, the post office and other delivery services. Delivery companies can benefit when consumers use the disclosed method to schedule a delivery that is directed to a consignee to reduce the number of attempts a delivery company needs to make to complete a delivery. Even if a delivery company redirects a package to a pick-up location after only one attempt for delivery to the consumer's location, this involves delivering the package first to the consumer location and then to the pick-up location. Accordingly, another revenue model for this method involves partnering with delivery companies. For example, if a delivery is ordered through the computing system that administers the subject method, each time the delivery company is able to complete the delivery in one attempt, the partnership agreement with the delivery company could include an agreement to pay the administrator of the method an agreed fee. If delivery companies are enabled to complete more deliveries with fewer attempts and re-directions the higher efficiency arising from this will result in a significant boost in productivity and/or lowering of the delivery company's cost of operations. This is just one example of a revenue model that includes the delivery companies. Since the benefits to delivery companies gives them an incentive to support the subject method, other revenue models might form a basis for partnership agreements, such as a fixed periodic fee based on bulk data relating to increased efficiencies arising from completing more deliveries with fewer attempts and re-directions. Alternatively, a partnership agreement could involve delivery companies offering reduced rates for consumers that use the subject method to enable delivery with fewer attempts. This provides a financial incentive for consumers to use the subject method and the delivery companies benefit by making more deliveries with fewer attempts and re-directions. For example, if the delivery charge is normally $5, if a consumer orders the delivery through an online portal associated with the subject method, then the delivery company could agree to charge a reduced rate of $4 if the delivery is completed on the first attempt. In yet another embodiment, the delivery charge is collected by the administrator of computing system 110, and when the delivery is completed on the first attempt then the delivery company is paid a reduced fee of $3.50 and the administrator retains $0.50 as a service fee. An added benefit of offering consumers reduced delivery rates is that it encourages consumers to continue to use the subject service. Once a consumer uses the system a few times and finds a consignee that is trustworthy there is a risk that the consumer will try to work with the consignee directly without using the service. Advantages like reduced delivery fees will not be available to the consumer if delivery arrangements are made directly with the consignee.

Some on-line stores offer consumers “free delivery” for certain items or when the consumer purchases more than a threshold amount. This is often used as a marketing incentive used by on-line retailers to remove a perceived barrier to making a purchase or to persuade a consumer to buy more items to exceed the threshold for free shipping. Most consumers understand that there is still a cost to the vendor for delivering the purchased item, and that “free shipping” just means that the delivery cost is incorporated into the purchase price. Accordingly, as an additional incentive to consumers, vendors that partner with the administrator of the subject peer-to-peer method could offer consumers a price discount if delivery is arranged through computing system 110 and if delivery is facilitated using the subject method.

In a more fully featured embodiment of the described improved consumer-focused delivery method, the method further comprises computing system 110 managing more of the delivery process, as shown by the method steps below the dotted horizontal line in FIG. 2. Instead of just validating a group of validated consignees in step 212a or generating a list of ranked validated consignees in step 214 and providing the ranked list in to the consumer in step 232 to facilitate matching the consumer with a validated consignee, computing system 110 can provide an interface for the consumer to select a consignee in method step 233 and to facilitate the financial aspects of the service. In step 233 the consumer selects a consignee from the identified group of validated consignees who are available to receive the purchased item that were shown to the consumer in step 232, and who have the characteristics in their consignee parameters that the consumer wants and values. In method step 215, computing system 110 then sends the delivery request to the selected consignee. In method step 223 the consignee receives the delivery request. In some embodiments, method step 223 can further comprise computing system 110 optionally requiring the selected consignee to send a message to the consumer (shown by a dashed line in FIG. 2) confirming receipt of the request for receiving a delivery and acknowledging that the consignee has accepted the request. If the consumer has used the consignee before and knows that the consignee will receive the purchased item, the consumer can over-ride the requirement for the consignee to acknowledge receipt of the request. Once the delivery request has been sent to the selected consignee, and the request has been acknowledged and accepted (if this is required), then in method step 216 computing system 110 collects the consignee's fee from the consumer and issues a release code to the consumer. The release code could be different or the same as the unique reference number that is associated with the delivery, which is used to verify authenticity of reviews and ratings. In some embodiments, it is the consumer who determines whether or not acknowledgement and acceptance of the delivery request by the consignee is required before the consumer is required to pay the fees payable to the consignee. Computing system 110 can be configured to include an administration fee together with the consignee's fee, with the administration fee retained by the administrator of computing system 110.

Normally the vendor will notify the consumer when the purchased item is delivered, or the vendor will give a tracking number to the consumer. As an extra feature, the consignee can notify the consumer through computing system 110 when the purchased item is received and ready for pick up. Alternatively, computing system 110 could be configured to receive the tracking information and automatically process it periodically to determine the delivery status and then notify the consumer when it is delivered.

When the purchased item is delivered to the consignee, in method step 234 the consumer arranges for retrieval of the purchased item from the consignee. In one embodiment the consumer can simply go to the consignee's location during times when the consumer knows that the consignee will be present and retrieve the purchased item. In method step 224 the consignee gives the purchased item to the consumer. With the subject method, the options available to the consumer for retrieving the purchased item are an improvement over delivery options that are currently available to consumers. The consumer chooses when to retrieve the item, and the consumer can select a consignee that is located in close proximity so that it is convenient to retrieve the item, and the consumer does not need to worry about the item being stolen if left by the delivery company on his or her front doorstep. In other embodiments, when the consumer knows that the item has been delivered, the consumer can contact the consignee and confirm a time for retrieving the item. In yet another embodiment, the consignee can offer an additional service, for an extra fee, for delivering the item to the consumer, as illustrated in FIG. 1 by truck symbol 124. The advantage of this over a traditional delivery company is the consumer can dictate a more precise time for having the purchased item delivered. If the consignee is nearby, there are less variables such as traffic that make deliveries by delivery companies less precise. The extra delivery charge can be competitive because the delivery distance can be very short, so not much time or vehicle fuel is needed to make the delivery, and this adds to the convenience made available to the consumer.

When the consumer retrieves the purchased item, the consumer gives the release code to the consignee as proof that the consumer is the purchaser of the delivered item. In method step 225 the consignee can enter the release code into computing system 110 to trigger payment of the consignee's fee in method step 217. Computing system 110 associates the release code with the delivery request, and knows which consignee was selected, so the release code can be used to trigger payment to the selected consignee. If the consignee provides its banking information to computing system 110 and authorizes computing system 110 to keep this information in memory, computing system 110 can automatically electronically deposit the fees into the consignee's bank account and send a record of the deposit to the consignee. Otherwise, consignee can choose other forms of payment, such as by cheque, but computing system 110 can be configured to charge a fee for issuing a cheque. The method can provide payment options to the consignee, including a monthly cheque to disburse aggregated fees earned on a monthly basis, which can be offered as an option for reducing the administrative fees for issuing cheques.

FIG. 2 also shows in method step 218 that computing system 110 can send a request to the consumer to submit a satisfaction rating or comment regarding the service provided by the consignee. In method step 235 the consumer can choose to give a satisfaction rating or comment, which is inputted into a database managed by computing system 110. The collected data can be compiled and used to make consumer comments and satisfaction ratings available to other consumers to help them to choose a suitable consignee.

Computing system 110 can also be configured with other features to improve the consumers' confidence in the delivery system. For example, computing system 110 can be configured to organize candidate consignees into geographic regions so that only consignees in a predetermined geographic region can register to offer consignee services in that region. The computing system can be configured to request the candidate consignee to give permission for the administrator of the computing system to perform background checks, which can include a process for verifying the identity of the consignee, that they are associated with the provided consignee address, criminal record checks, credit checks, and reference checks for references provided by the candidate consignee. Alternatively, instead of, or in addition to the administrator perform background checks, computer system 110 can be configured to collect specific information from the candidate consignee to confirm identity and to support the good character of the candidate consignee, and to refuse registration if such information is not submitted.

Candidate consignees could move or may choose to withdraw from being a candidate consignee. Computing system 110 can be configured to accept notices from the candidate consignee that they no longer wish to participate in the delivery program. Consumers want to be confident that the candidate consignee information is up to date. Not all candidate consignees will be diligent in pro-actively withdrawing from the delivery program if they are no longer available to accept deliveries. This can be frustrating for consumers if they select a candidate consignee, but they later discover that the selected consignee is no longer available. The computing system can be configured to automatically send a periodic communication to candidate consignees, requiring them to confirm that they are still available to receive purchased items. This communication can include the consignee parameters associated with the candidate consignee and invite them to update their parameters if any changes. If a candidate consignee does not confirm availability and that the consignee parameters are up to date, the candidate consignee the computing system can be configured to remove the candidate consignee from pool 120. Once removed, if a candidate consignee again wants to participate in the delivery program, a new request can be submitted to be admitted back into pool 120.

Computing system 110 can also be configured to offer insurance to consumers. As an added advantage to using the subject service, part of the administration fees collected from users can be used to fund an insurance policy to afford consumers some protection against damage to packages when in the care of consignees. The terms of use with consumers can specify limits on the amounts payable when a claim is made, and for expensive items consumers can be given the option of buying additional insurance to cover the actual value of the item being delivered, or some other amount specified by the consumer. This is another feature of the subject method that could encourage consumers to continue to use the subject service, instead of making arrangements directly with a consignee.

Acts associated with any of the method embodiments described herein can be implemented as coded instructions in a computer program product. That is, the computer program product is a computer readable medium upon which software code is recorded to execute the method when the computer program product is loaded into memory and executed on the microprocessor of a computing system. This computer program product can be sold or leased to franchises or other companies wanting to act as administrators operating in different geographical regions.

While the illustrated embodiments show particular examples, various modifications and alterations can be made to the examples within the scope of the claims and aspects of the different examples can be combined in different ways to achieve further examples. Accordingly, the scope of the claims is to be understood from the entirety of the present disclosure in view of, but not limited to the embodiments illustrated and described herein. That is, with the benefit of the teachings of this disclosure it will be apparent that various modifications and variations can be made without departing from the spirit or scope of the claims.

What is claimed is:

1. A method for facilitating delivery services, the method being performed by a computing system and comprising:
processing a request from a candidate consignee to be included in a pool of consignees within a geographic region, this step comprising collecting consignee parameters including consignee location, times when available for receiving deliveries, times when available for deliveries to be picked up by consumers, fees, and contact information;
admitting said candidate consignee into said pool of consignees if said candidate consignee satisfies predetermined criteria for admission;
processing a delivery request entered into said computing system by a consumer, said delivery request comprising consumer input on at least one delivery criterion selected from a list of predetermined delivery criteria;
validating a group of validated consignees from said pool that satisfy all delivery criteria entered by said consumer; and
identifying to said consumer said group of validated consignees.

2. The method of claim 1 wherein said list of predetermined delivery criteria entered into said computing system by said consumer comprises at least one of: distance from a specified location, fees, times available when said consignee is available for receiving deliveries, times available when consignee is available for deliveries to be picked up, and a rating assigned to consignees by other consumers.

3. The method of claim 1 further comprising applying a predetermined ranking method based upon said consumer input in said delivery request and assigning ranks to said validated consignees.

4. The method of claim 3 wherein if distance from a specified location within said geographic region is one of said selected delivery criteria, said ranking method calculates and communicates to said consumer distances between each validated consignee and said specified location.

5. The method of claim 3 wherein said consumer can override said predetermined ranking method by entering consumer-defined weightings to the selected delivery criteria whereby said computing system assigns customized rankings to validated consignees according to a consumer's individual preferences.

6. The method of claim 1 further comprising said computing system soliciting and collecting from consumers, quantifiable satisfaction ratings for consignees in said pool of consignees and including said quantifiable satisfaction ratings on said predetermined list of delivery criteria.

7. The method of claim 6 further comprising said computing system soliciting and collecting from consignees, quantifiable satisfaction ratings for consumers, and wherein consignees can include in their individual consignee parameters a minimum satisfaction rating for consumers, for accepting delivery requests, whereby a consignee is not included in said group of validated consignees for a delivery request when said delivery request is received from a consumer with a satisfaction rating below said minimum satisfaction rating for consumers.

8. The method of claim 1 further comprising said computing system soliciting and compiling reviews of consignees from consumers concerning consignees in said pool and making said reviews of consignees available to consumers.

9. The method of claim 8 further comprising said computing system soliciting and compiling reviews of consumer from consignees concerning consumers who have used the method for facilitate delivery services and making said reviews of consumers available to consignees in said pool of consignees.

10. The method of claim 9 further comprising managing said reviews of consignees and said reviews of consumers by doing at least one of:
verifying that reviews are authentic;
providing a process for responding to reviews; or
taking down reviews that do not comply with predetermined guidelines for appropriate content.

11. The method of claim 1 wherein said predetermined criteria for admission comprises at least one of:
information that verifies the identity of said candidate consignee; and
information that supports the trustworthiness of said candidate consignee.

12. The method of claim 1 further comprising:
said consumer choosing a selected consignee from said group of validated consignees and entering said selected consignee into said computing system;
said computing system sending the delivery request to said selected consignee;
said computing system collecting the selected consignee's fee from said consumer and issuing a release code to said consumer;
said consumer giving said release code to said selected consignee to collect a delivered item; and
said selected consignee entering said release code into said computing system to trigger disbursement of the selected consignee's fees to the selected consignee.

13. The method of claim 12 further comprising said selected consignee notifying said consumer through said computing system when said delivered item has been received.

14. The method of claim 12 further comprising said consumer and said selected consignee communicating through said computing system to coordinate a confirmed time for said consumer to pick up said delivered item from said selected consignee.

15. The method of claim 12 wherein said selected consignee's fee includes an administration fee retained by the administrator of said computing system.

16. The method of claim 15 wherein said administration fee entitles consumers to make claims against an insurance policy if said delivered item is damaged while in the care of said selected consignee.

17. The method of claim 12 wherein said selected consignee can include an offer through said computing system to deliver received items to said specified location at a time determined by said consumer for an additional fee.

18. A computer program product for facilitating delivery services, the computer program product comprising code which, when loaded into memory and executed on a processor of a computing device, is adapted to execute the method according to claim 1.

19. The computer program product of claim 18 further comprising additional code, which when loaded into memory and executed on said processor of said computing device, is adapted to execute the additional method steps according to claim 12.

20. A system for facilitating delivery services, comprising:
a consignee interface device configured to receive a request from a candidate consignee to be included in a pool of consignees within a geographic region, said request including consignee parameters including consignee location, fees, times when available for receiving deliveries, and times when available for retrieval of delivered items by consumers, and contact information;
a consumer interface device configured to receive a delivery request from a consumer said delivery request comprising consumer input on at least one delivery criterion selected from a list of predetermined delivery criteria;
a computing system communicatively coupled to said consumer interface device and said consignee interface device; the computing system configured to:
admit said candidate consignee into said pool of consignees if said candidate consignee satisfies predetermined criteria for admission;
validate a group of validated consignees from said pool of consignees that satisfy all delivery criteria entered by said consumer; and
identify validated consignees and associated consignee parameters to said consumer.

21. The system of claim 20 wherein said list of predetermined delivery criteria entered into said computing system by said consumer comprises at least one of: distance from a specified location, fees, times available when said consignee is available for receiving deliveries, times available when consignee is available for deliveries to be picked up, and a rating assigned to consignees by other consumers.

22. The system of claim 20 wherein said computing system is configured to apply a predetermined ranking method based upon said consumer input in said delivery request and to communicate an assigned rank to each one of said validated consignees to said consumer through said consumer interface device.

23. The system of claim 22 wherein said consumer can override said predetermined ranking method through said consumer interface device by entering consumer-defined weightings to the selected delivery criteria whereby said computing system uses said consumer-defined weightings to compute and assign customized rankings to validated consignees according to a consumer's individual preferences.

24. The system of claim 20 wherein said computing system is configured:
to solicit from consumers, through said consumer interface device, quantifiable satisfaction ratings for consignees in said pool of consignees;
to save said quantifiable satisfaction ratings, to include satisfaction ratings on said predetermined list of delivery criteria; and
to make said quantifiable satisfaction ratings available to consumers through said consumer interface device.

25. The system of claim 24 wherein said computing system is configured to solicit, through said consignee interface device, and to save, quantifiable satisfaction ratings for consumers from consignees, and wherein consignees can include in their individual consignee parameters a minimum satisfaction rating for accepting delivery requests, whereby a consignee will not be included in said group of validated consignees for a delivery request received from a consumer with a satisfaction rating below said minimum satisfaction rating.

26. The system of claim 20 wherein said computing system is configured to solicit, through said consumer interface device, reviews of consignees from consumers concerning consignees in said pool; to compile said reviews of consignees; and to make said reviews of consignees available to consumers through said consumer interface device.

27. The system of claim 26 wherein said computing system is configured to solicit, through said consignee interface device, reviews of consumers from consignees concerning consumers who have used the method for facilitate delivery services; to compile said reviews of consumers; and, to make said reviews of consumers available to consignees in said pool of consignees through said consignee interface device.

28. The system of claim 27 wherein said computing system is configured to manage said reviews of consignees and said reviews of consumers by doing at least one of:
verifying that reviews are authentic;
providing a process for responding to reviews; or
taking down reviews that do not comply with predetermined guidelines for appropriate content.

29. The system of claim 20 wherein said predetermined criteria for admission comprises at least one of:
information that verifies the identity of said candidate consignee; and
information that supports the trustworthiness of said candidate consignee.

30. The system of claim 20 wherein said computing system is configured to:
receive a consumer selection, through said consumer interface device, of a selected consignee from said group of validated consignees;
send the delivery request to said selected consignee through said consignee interface device;
collect the selected consignee's fee from said consumer and issuing a release code to said consumer, said release code allowing said consumer to collect a delivered item from said selected consignee; and
disburse the selected consignee's fee to said selected consignee when said selected enters said release code into said computing system through said consignee interface device.

31. The system of claim 30 further comprising said consumer and said selected consignee communicating through said computing system by means of respective consumer and consignee interface devices to coordinate a confirmed time for said consumer to pick up said delivered item from said selected consignee.
